(19) United States
(12) Patent Application Publication
(10) Pub. No.: US 2023/0360420 A1
(43) Pub. Date: Nov. 9, 2023

(54) DOCUMENT IMAGE CAPTURE

(71) Applicant: Hewlett-Packard Development Company, L.P., Spring, TX (US)

(72) Inventors: Lucas Nedel Kirsten, Porto Alegre (BR); Sebastien Tandel, Porto Alegre (BR); Carlos Eduardo Leao, Porto Alegre (BR); Juliano Cardoso Vacaro, Porto Alegre (BR)

(73) Assignee: Hewlett-Packard Development Company, L.P., Spring, TX (US)

(21) Appl. No.: 18/028,531

(22) PCT Filed: Oct. 14, 2020
(86) PCT No.: PCT/US2020/055487

§ 371 Date: Mar. 25, 2023

(51) Int. Cl. G06V 10/44; G06V 30/10; H04N 23/695; G06V 30/41

(52) U.S. Cl. CPC G06V 30/41; G06V 10/44; G06V 30/10; H04N 23/695

(57) ABSTRACT

Upon placement of a camera-facing surface of a camera device on a document or upon parallel positioning of the camera-facing surface close to and over the document, images are continually captured by an image capturing sensor of the camera device. While the camera device is being raised above the document, whether the document is fully included within a captured image is detected. In response to detecting that the document is fully included within the captured image, the captured image that fully includes the document is selected as a document image.

### BACKGROUND

While information is increasingly communicated in electronic form with the advent of modern computing and networking technologies, physical documents, such as printed and handwritten sheets of paper and other physical media, are still often exchanged. Such documents can be converted to electronic form by a process known as optical scanning. Once a document has been scanned as a digital image, the resulting image may be archived, or may undergo further processing to extract information contained within the document image so that the information is more usable. For example, the document image may undergo optical character recognition (OCR), which converts the image into text that can be edited, searched, and stored more compactly than the image itself.

### BRIEF DESCRIPTION OF THE DRAWINGS

FIGS. 1A and 1B are flowcharts of an example method for guiding a user so that a camera device digitally captures an image fully including a document.

FIGS. 2A and 2B are diagrams of example placement of a camera device centered on a document to be digitally captured within an image by the camera device.

FIG. 3A is a diagram of example raising of a camera device above a document to be digitally captured within an image by the camera device.

FIGS. 3B and 3C are diagrams depicting example detection by a camera device that the camera device is being raised above a document.

FIG. 4A is a diagram of example tilting of a camera device relative to a document above which the camera device has been raised.

FIG. 4B is a diagram depicting example detection by a camera device that the device has been tilted relative to a document above which the device has been raised.

FIG. 5A is a diagram depicting example movement of a camera device off-center relative to a document above which the camera device has been raised.

FIG. 5B is a diagram depicting example detection by a camera device that the device has been moved off-center relative to a document above which the device has been raised.

FIG. 6 is a diagram of an example image fully including a document that a camera device has digitally captured.

FIG. 7 is a diagram of an example non-transitory computer-readable data storage medium storing program code for guiding a user so that a camera device digitally captures an image fully including a document.

FIG. 8 is a block diagram of an example camera device that can guide a user so that the camera device digitally captures an image fully including a document.

### DETAILED DESCRIPTION

As noted in the background, a physical document can be scanned as a digital image to convert the document to electronic form. Traditionally, dedicated scanning devices have been used to scan documents to generate images of the documents. Such dedicated scanning devices include sheetfed scanning devices, flatbed scanning devices, and document camera scanning devices. However, with the near ubiquitousness of smartphones and other usually mobile computing devices that include cameras and other types of image-capture sensors, documents are often scanned with such non-dedicated scanning devices. Such non-dedicated scanning devices may also be referred to as camera devices, in that they include a camera or other type image-capturing sensor that can digitally capture an image of a document.

When scanning a document using a dedicated scanning device, a user can often successfully position the document in relation to the device by touch. Therefore, a user who is visually impaired can still relatively easily scan documents using a dedicated scanning device. For example, a flatbed scanning device may have a lid that a user lifts, and a glass flatbed on which the user positions the document. The user then lowers the lid, and may press a button on the device to initiate scanning. A sheetfed scanning device may have media guides between which a user inserts a document, and likewise may have a button that the user presses to initiate scanning.

By comparison, when scanning a document using a non-dedicated scanning device, a user may often has to rely primarily on sight to successfully position the device in relation to the document. Therefore, a user who is visually impaired may be unable to easily scan documents using such a camera device. For example, a user generally has to place a document on a flat surface like a tabletop or desktop, and aim the camera device towards the document while viewing a display on the device to verify that the document is fully framed within the field of view of the device. The user may have to move the camera device towards or away from the document, tilt the device relative to the document, and/or move the device up, down, left, or right before the document is properly framed within device’s field of view.

Techniques described herein guide a user so that a camera device digitally captures an image that fully includes a document. The user can be guided as to how to position the camera device relative to the document so that the document is successfully captured within an image. A user therefore does not have to rely on sight to scan a document using a camera device like a smartphone or other mobile computing device. The techniques can instead audibly guide the user, such as via speech or sound. Proper positioning of the camera device relative to the document so that an image fully including the document can be successfully captured can be detected via sensors of the device. The techniques described herein can thus permit visually impaired users to more easily scan documents with their camera devices.

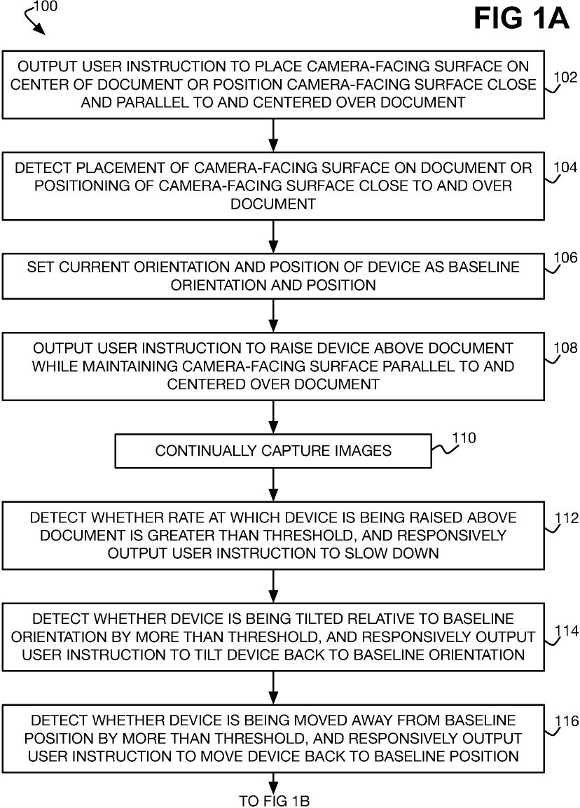

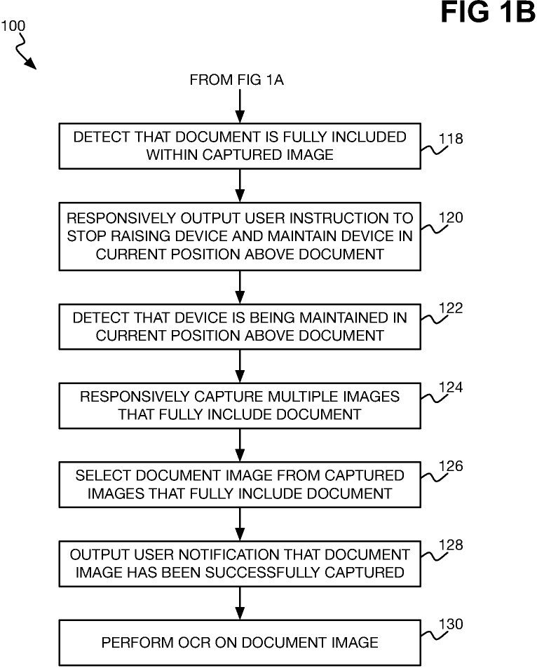

FIGS. 1A and 1B show an example method 100 for guiding a user so that a camera device digitally captures an image fully including a document. The method 100 may be implemented as program code stored on a non-transitory computer-readable data storage medium and executable by the camera device. The camera device may be a smartphone that has a display on one side and an image-capturing sensor that the lens for which is exposed at the other side, which is referred to as the camera-facing surface of the camera device. The camera device may have a speaker to output sound, including speech, and may have an actuator, such as an eccentric rotating mass (ERM) actuator, a linear resonant actuator (LRA), or a piezoelectric actuator, to provide haptic feedback.

The method 100 can include outputting a user instruction to place the camera-facing surface of the camera device on the center of the document to be scanned, or to hold the device so that this surface is positioned close and parallel to and centered over the document (102). The camera device may audibly output the user instruction, such as via speech. The method 100 can include detecting the placement of the camera-facing surface of the camera device on the document or the positioning of this surface close to and over the document (104).

The camera device may detect the placement of the camera-facing surface on the document or the positioning of this surface close to the document from an image that the device captures. When the camera-facing surface is placed against the document, no or minimal light reaches the camera device’s image-capturing sensor through the lens at this surface. Similarly, when the camera-facing surface is positioned close to the document, less light may reach the sensor than if the device is positioned farther above the document. Therefore, the camera device may detect placement on the document or positioning close to the document by detecting that a captured image is blacked out by more than a threshold. The threshold thus implicitly defines how close the camera-facing surface of the device has to be positioned to the document.

The camera device may be unable to detect that the camera-facing surface has been placed on the center of the document, or that this surface is being positioned parallel to and centered over the document. However, a user, including one who is visually impaired, will likely be able to place or position the camera device relative to the document in this way by touch, without having to rely on sight to visually confirm via the device’s display such placement or positioning. Once the camera device has detected placement on or positioning close to the document, the device may provide confirmation, such as haptically or audiblly (e.g., via speech or sound).

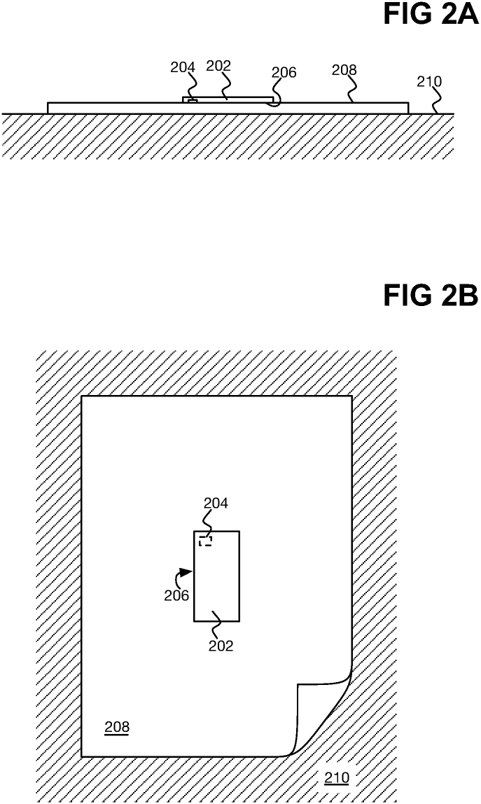

FIGS. 2A and 2B are front and top view diagrams of example placement of a camera device 202 centered on a document 208 disposed on a surface 210, such as a tabletop or a desktop surface. The camera device 202 includes an image-capturing sensor 204 that can continually capture images incident to a camera-facing surface 206 of the device 202. For instance, the camera device 202 may have a lens at the surface 206 through which light enters and reaches the sensor 204. (The camera device 202 may have a display on the surface opposite the surface 206.) Because the surface 206 is in contact with the document 206, the images captured by the sensor 204 are blacked out. The images may have minimum brightness or brightness less than a threshold, for instance, and/or the image pixels may have minimum pixel values or pixel values less than a threshold.

Referring back to FIG. 1A, the method 100 can include, upon placement of the camera-facing surface on the document or positioning of this surface close and parallel to and over the document, setting the current orientation and current position of the camera device as the baseline orientation and position (106). The baseline orientation may be the camera device’s current rotational orientation in three-dimensional (3D) space, which a gyroscope sensor of the device may provide. The baseline position may be the device’s current translational position in 3D space, which an accelerometer sensor of the device may provide. The baseline orientation and position can be set responsive to detecting placement of the camera-facing surface on or positioning of this surface close to the document.

The method 100 can include outputting a user instruction to raise the camera device above the document while maintaining the camera-facing surface parallel to and centered over the document (108). The camera device may audibly output the user instruction, such as via a spoken instruction. While the camera device is being raised above the document, such as responsive to detection of such raising of the device, the method 100 can include continually capturing images via the image-capturing sensor of the device (110). That is, upon the placement of the camera-facing surface on the document or positioning of this surface close to and over the document, and as the camera device is then raised above the document, the device continually captures images.

If the user raises the camera device too quickly, however, then the document may be blurry within the captured images (i.e., image quality may decrease). The method 100 can therefore include detecting whether the rate at which the device is being raised above the document is greater than a threshold, and responsively outputting a user instruction to slow down (112). The threshold may correspond to the rate greater than which the captured images become too blurry. The device may audibly output the user instruction, such as via speech. If the camera device includes an accelerometer sensor, then the device can use this sensor to detect that the user is raising the device too quickly. The camera device may also or instead analyze successively captured images to detect that the user is raising the device too quickly.

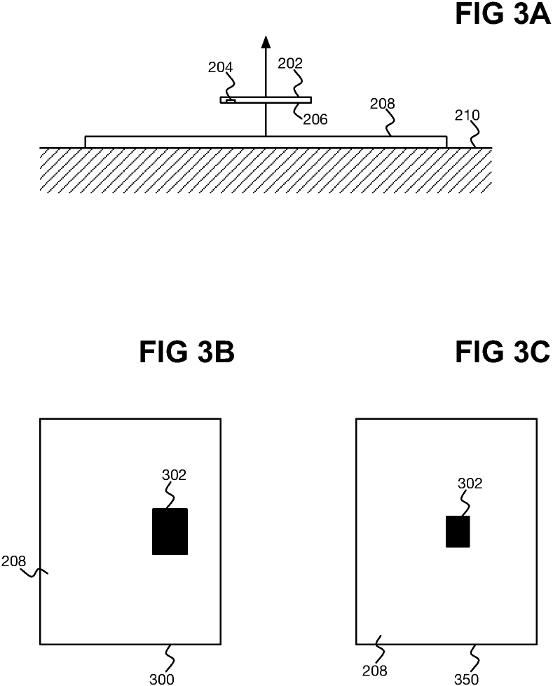

FIG. 3A shows a front view diagram of example raising of the camera device 202 above the document 208 on the surface 210 while the camera-facing surface 206 at which the image-capturing sensor 204 receives light is maintained parallel to and centered over the document 208. As noted, if the camera device 202 includes an accelerometer sensor, then the device 202 can detect that the user is raising the device 202 too quickly by using this sensor. However, if the camera device 202 lacks an accelerometer sensor, or even if the device 202 includes this sensor, the device 202 can also as noted detect that the user is raising the device 202 too quickly by analyzing successively captured images.

FIGS. 3B and 3C show an example of how the camera device 202 can detect that the user is raising the device 202 too quickly by analyzing successively captured images. The digitally captured images 300 and 350 of the document 208 include an image feature 302, which in the example is a rectangle. Between the time of capture of the image 300 of FIG. 3A and the time of capture of the image 350 of FIG. 3B, the camera device 202 has been raised. Therefore, the field of view of the camera device 202 is larger in the image 350, and the feature 302 is accordingly smaller in size. The camera device 202 can thus track the decrease in size of the feature 302 over successively captured images 300 and 350 to detect whether the user is raising the device 202 too quickly above the document 208.

Referring back to FIG. 1A, if the user tilts the camera device too much, the document may become distorted within the captured images. The method 100 can therefore include detecting whether the device is being tilted relative to the baseline orientation by more than a threshold, and responsively outputting a user instruction to tilt the device back to the baseline orientation (114). The instruction may specify the direction in which the user has to tilt the device to return it back to the baseline orientation. The device may audibly output the user instruction, and may provide audible or haptic feedback when the device has returned to the baseline orientation. The camera device may use a gyroscope sensor to detect tilting if the device includes this sensor, and may additionally or instead analyze successively captured images to detect tilting.

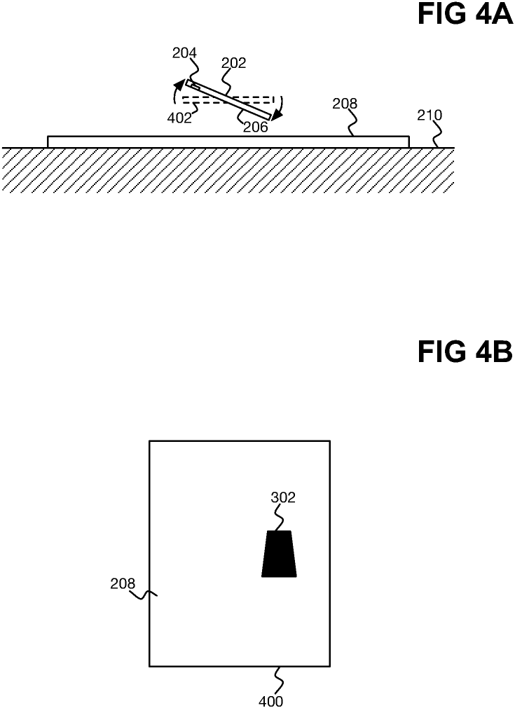

FIG. 4A shows a front view diagram of example tilting of the camera device 202 relative to a baseline orientation 402 in which the camera-facing surface 206 at which the image-capturing sensor 204 receives light is parallel to and above the document 208 on the surface 210. As noted, if the camera device 202 includes a gyroscope sensor, the device 202 can detect that the user has tilted the device 202 by more than a threshold. However, if the camera device 202 lacks a gyroscope sensor, or even if the device 202 includes this sensor, the device 202 can also as noted detect that the user has tilted the device 202 too much by analyzing successfully captured images.

FIG. 4B shows an example of how the camera device 202 can detect that the user has tilted the device 202 too much by analyzing successively captured images, in relation to FIG. 3A. The digitally captured image 400 of the document 208 again includes the image feature 302. Between the time of capture of the image 300 of FIG. 3A and the time of capture of the image 400 of FIG. 4B, the camera device 202 has been tilted. Therefore, the feature 302 is distorted in FIG. 4B. That is, while initially rectangular in shape in the image 300, the feature 302 has become distorted in perspective and is trapezoidal in shape in the image 400. The camera device 202 can thus track perspective distortion of the feature 302 over successively captured images 300 and 400 to detect whether the user is tilting the device 202 too much.

Referring back to FIG. 1A, if the user moves the camera device too much off document center, the document may not become fully included within the captured images at all or may be too small in size if does. The method 100 can therefore include detecting whether the device is being moved away from the baseline position by more than a threshold, and responsively outputting a user instruction to move it back to the baseline position (116). The instruction may specify the direction in which the user has to move the device to return it back to the baseline position. The device may audibly output the instruction, and may provide feedback when the device has returned to the baseline position. The device may use an accelerometer to detect movement if it includes this sensor, and may also or instead analyze successively captured images.

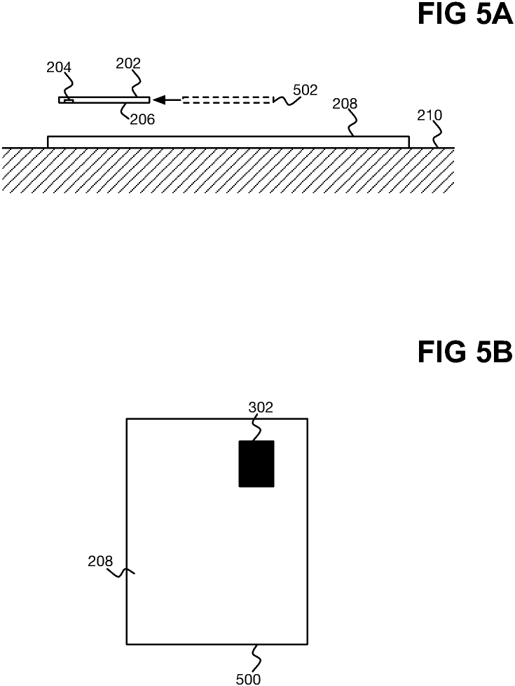

FIG. 5A shows a front view diagram of example movement of the camera device 202 away from the baseline position 502 in which the camera-facing surface 206 at which the image-capturing sensor 204 receives light is parallel to and centered above the document 208 on the surface 210. As noted, if the camera device 202 includes an accelerometer sensor, the device 202 can detect that the user has moved the device 202 off document center by more than a threshold. However, if the camera device 202 lacks an accelerometer sensor, or even if the device 202 includes this sensor, the device 202 can also as noted detect that the user has moved the device 202 too much off document center by analyzing successively captured images.

FIG. 5B shows an example of how the camera device 202 can detect that the user has moved the device 202 too much off document center by analyzing successively captured images, in relation to FIG. 3A. The digitally captured image 500 of the document 208 again includes the image feature 302. Between the time of capture the image 300 of FIG. 3A and the time of capture of the image 500 of FIG. 5B, the device 202 has been moved off document center. Therefore, the feature 302 has shifted in position (specifically upwards) in the image 500. The camera device 202 can thus track positional shifting of the feature 302 over successively captured images 300 and 500 to detect whether the user is moving the device 202 too much off document center.

Referring to FIG. 1B, the method 100 can include detecting that the document is fully included within a captured image (118). The camera device can detect that the document is fully included within an image that the image-capturing sensor has captured as the device is being raised above the document. Detection that the document is fully included within an image may be achieved using the technique described in J. Fan, “Enhancement of camera-captured document images with watershed segmentation,” in Proceedings of the International Workshop on Camera-Based Document Analysis and Recognition (CBDAR) (2007).

The method 100 can include responsively outputting a user instruction to stop raising the camera device and to maintain the device still in its current position over the document (120). The camera device may audibly output the instruction. The method 100 can include detecting that the camera device is being maintained in its current position above the document (122). That is, the camera device can detect that the device is stationary and is not being moved or rotated. For instance, the camera device may use accelerometer and gyroscope sensors to detect that the device is being maintained in position, and/or may track perspective distortion and positional shifting of corresponding image features over successively captured images, as has been described.

The method 100 can include responsively capturing multiple images that fully include the document (124), and selecting a document image from these captured images (126). The captured images may fully include the document because the device has minimally moved since an image that fully includes the document was previously detected while the device was still being raised. The camera device captures images after it is no longer being raised because such images are more likely to have better image quality than images captured while the device is being raised. Images captured while the camera device is being raised may be blurry, for instance. The device may select as the document image the captured image that has the highest image quality.

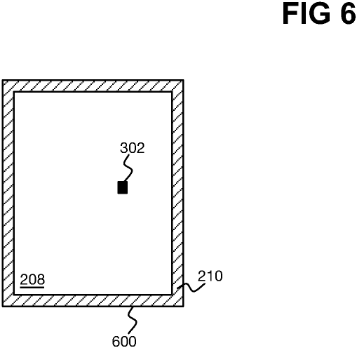

FIG. 6 shows an example image 600 that fully includes the document 208 having the image feature 302. The camera device may detect the image 600 as fully including the document 208 by detecting a region within the image 600 corresponding to the document and determining that this region does not extend to any edge of the image 600. That is, the camera device can detect one or multiple other regions corresponding to the surface 210 (on which the document 208 is lying) along one or multiple edges of the image 600, and/or can detect every edge and corner of the document 208 against the surface 210 within the image 600. The camera device can thus conclude that the document image 600 does indeed fully include the document 208.

Referring back to FIG. 1B, the method 100 can include outputting a user notification that the document image (i.e., an image that fully includes the document) has been successfully captured (128). The user can cease maintaining the camera device in a stationary position above the document. The method 100 therefore guides a user in positioning the camera device relative to the document so that the device can successfully scan the document, without the user having to rely on sight. The method 100 may conclude by performing OCR (or another image processing or other action) on the document image (130).

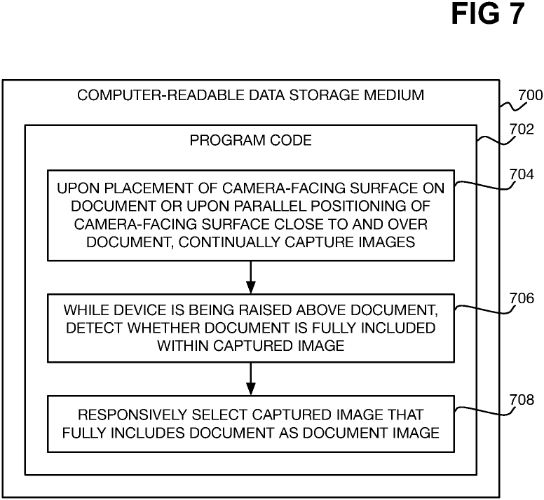

FIG. 7 shows an example non-transitory computer-readable data storage medium 700 storing program code 702 executable by a camera device to perform processing. The processing includes, upon placement of a camera-facing surface of the camera device on a document or upon parallel positioning of the camera-facing surface close to and over the document, continually capturing images by an image-capturing sensor of the camera device (704). The process includes, while the camera device is being raised above the document, detecting whether the document is fully included within a captured image (706). The processing includes, in response to detecting that the document is fully included within the captured image, selecting the captured image that fully includes the document as a document image (708).

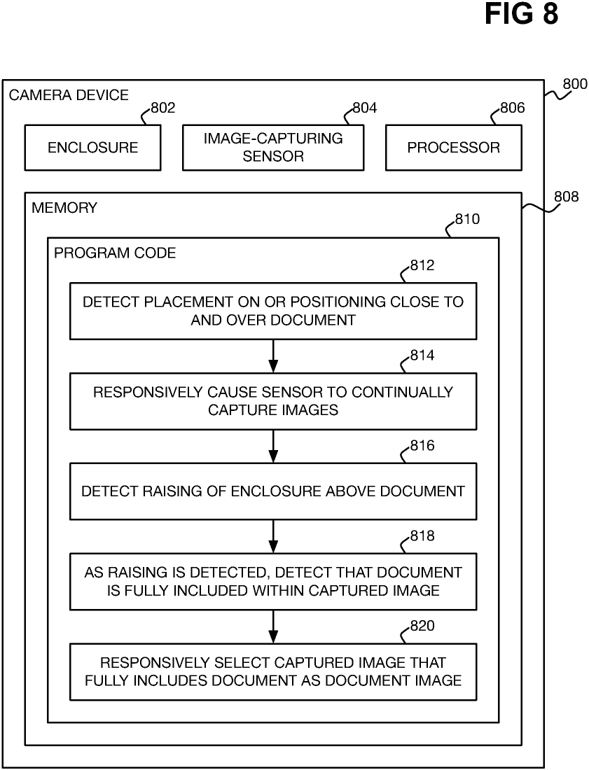

FIG. 8 shows an example camera device 800. The camera device 800 includes an enclosure 802 and an image-capturing sensor disposed at a surface of the enclosure 804 to capture images of a document. The device 800 includes a processor 806 and a memory 808 storing program code 810. The code 810 is executable by the processor 806 to detect placement of the surface on the document or positioning of the surface close to and over the document (812), and responsively cause the image-capturing sensor to continually capture the images (814). The code 810 is executable by the processor 806 to detect raising of the enclosure above the document (816) and, as the raising of the enclosure detected, detect that the document is fully included within a captured image (818). The code 810 is executable by the processor 806 to responsively select the image that fully includes the document as a document image (820).

Techniques have been described for using a camera device to capture an image that includes a document, in which the camera device guides a user in positioning the device relative to the document so that it can successfully capture the document image. The user does not have to rely on sight in order to scan the document using the camera device. Therefore, a user who is visually impaired can use a camera device such as a smartphone to more easily perform document scanning.

We claim:

1. A non-transitory computer-readable data storage medium storing program code executable by a camera device to perform processing comprising:
upon placement of a camera-facing surface of the camera device on a document or upon parallel positioning of the camera-facing surface close to and over the document, continually capturing images by an image-capturing sensor of the camera device;
while the camera device is being raised above the document, detecting whether the document is fully included within a captured image; and
in response to detecting that the document is fully included within the captured image, selecting the captured image that fully includes the document as a document image.

2. The non-transitory computer-readable data storage medium of claim 1, wherein the processing further comprises:
performing optical character recognition (OCR) on the document image.

3. The non-transitory computer-readable data storage medium of claim 1, wherein the processing further comprises:
detecting the placement of the camera-facing surface on the document or the parallel positioning of the camera-facing surface close to and over the document by detecting that a captured image is blacked out by more than a threshold.

4. The non-transitory computer-readable data storage medium of claim 1, wherein the processing further comprises:
outputting a user instruction to place the camera-facing surface on a center of the document or to position the camera-facing surface parallel and close to and centered over the document; and
upon the placement of the camera-facing surface of the camera device on the document or upon the parallel positioning of the camera-facing surface close to and over the document, outputting a user instruction to raise the camera device over the document while maintaining the camera-facing surface parallel to and centered over the document.

5. The non-transitory computer-readable data storage medium of claim 1, wherein the processing further comprises:
detecting whether a rate at which the camera device is being raised above the document above the document is greater than a threshold; and
in response to detecting that the rate at which the camera device is being raised above the document is greater than the threshold, outputting a user instruction to slow down the rate at which the camera device is being raised above the document.

6. The non-transitory computer-readable data storage medium of claim 5, wherein detecting the rate at which the camera device is being raised above the document comprises one or both of:
using an accelerometer sensor of the camera device;
tracking a decrease in size of corresponding image features over successively captured images.

7. The non-transitory computer-readable data storage medium of claim 1, wherein the processing further comprises:
upon the placement of the camera-facing surface of the camera device on the document or upon the parallel positioning of the camera-facing surface close to and over the document, setting a current orientation of the camera device as a baseline orientation corresponding to document;
while the camera device is being raised above the document, detecting whether the camera device is being tilted relative to the baseline orientation by more than a threshold; and
in response to detecting that the camera device is being tilted relative to the baseline orientation by more than the threshold, outputting a user instruction to tilt the camera device to return the camera device to the baseline orientation.

8. The non-transitory computer-readable data storage medium of claim 7, wherein detecting whether the camera device is being tilted relative to the baseline orientation comprises one or both of:
using a gyroscope sensor of the camera device;
tracking perspective distortion of corresponding image features over successively captured images.

9. The non-transitory computer-readable data storage medium of claim 1, wherein the processing further comprises:
upon placement of the camera-facing surface of the camera device on the document or upon the parallel positioning of the camera-facing surface close to and over the document, setting a current position of the camera device as a baseline position corresponding to document;
while the camera device is being raised above the document, detecting whether the camera device is being moved away from the baseline position by more than a threshold; and
in response to detecting that the camera device is being moved away from the baseline position by more than the threshold, outputting a user instruction to move the camera device to return the camera device to the baseline position.

10. The non-transitory computer-readable data storage medium of claim 9, wherein detecting whether the camera device is being moved away from the baseline position comprises one or both of:
using an accelerometer sensor of the camera device;
tracking positional shifting of corresponding image features over successively captured images.

11. The non-transitory computer-readable data storage medium of claim 1, wherein the processing further comprises:
in response to detecting that the document is fully included within the captured image, detecting whether the camera device is being maintained in a current position above the document;
wherein the captured image that fully includes the document is selected as the document image in response to detecting that the camera device is being maintained in the current position above the document.

12. The non-transitory computer-readable data storage medium of claim 11, wherein detecting whether the camera device is being maintained in a current position above the document comprises one or both of:
using an accelerometer sensor and a gyroscope sensor of the camera device;
tracking perspective distortion and positional shifting of corresponding image features over successively captured images.

13. The non-transitory computer-readable data storage medium of claim 1, wherein the processing further comprises:
in response to detecting that the document is fully included within the captured image, outputting a user instruction to stop raising the camera device and to maintain the camera device in a current position over the document; and
after the captured image that fully includes the document has been selected as the document image, outputting a user notification that the document image has been successfully captured.

14. The non-transitory computer-readable data storage medium of claim 1, wherein selecting the captured image that fully includes the document as the document image comprises:
selecting the captured image as the document image from more than one captured image that fully include the document.

15. A camera device comprising:
an enclosure;
an image-capturing sensor disposed at a surface of the enclosure to capture images of a document;
a processor;
a memory storing program code executable by the processor to:
detect placement of the surface on the document or positioning of the surface close to and over the document;
responsively cause the image-capturing sensor to continually capture the images;
detect raising of the enclosure above the document;
as the raising of the enclosure above the document is detected, detect that the document is fully included within a captured image; and
responsively select the captured image that fully includes the document as a document image.
